(19) United States
(12) Patent Application Publication
(10) Pub. No.: US 2026/0312342 A1
(43) Pub. Date: Oct. 8, 2026

(54) ELECTRICAL CONNECTION DEVICE

(71) Applicant: SHENG-HSIN LIAO, NEW TAIPEI CITY (TW)

(72) Inventor: SHENG-HSIN LIAO, NEW TAIPEI CITY (TW)

(21) Appl. No.: 19/640,447

(22) Filed: Apr. 7, 2026

(30) Foreign Application Priority Data
Apr. 8, 2025 (TW) 114203426

(51) Int. Cl. H01R 13/713; H01R 13/70; H01R 13/703; H01R 13/717; H01R 24/28; H01R 24/62

(52) U.S. Cl. CPC H01R 13/713; H01R 13/701; H01R 13/7033; H01R 13/7035; H01R 13/717; H01R 24/28; H01R 24/62; H01R 2201/06

(57) ABSTRACT

An electrical connection device includes a base, a terminal set, a circuit board, a switch unit, a housing, and a grip member. The terminal set is disposed on the base. The terminal set includes a plurality of terminals. One end of each of the plurality of terminals is electrically connected to the circuit board. The switch unit is electrically connected to the circuit board. The housing covers the base and the circuit board. The grip member is disposed around the housing. The grip member can move on the housing along an insertion direction and a withdrawal direction to control the switch unit to be turned on and off, so that when the electrical connection device is plugged into or unplugged from a mating electronic device, conduction occurs only after complete plugging, and power is cut off before complete unplugging, thereby preventing an arc discharge phenomenon.

### CROSS-REFERENCE TO RELATED PATENT APPLICATION

This application claims the benefit of priority to Taiwan Patent Application No. 114203426, filed on Apr. 8, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connection device, and more particularly to an electrical connection device capable of reducing an arc discharge phenomenon.

### BACKGROUND OF THE DISCLOSURE

In related art, USB connectors have been widely used as data transmission interfaces and may also serve as charging connectors. As transmission rates of USB connectors continue to increase, various specifications have been developed accordingly, with the latest being the Type-C connector. However, in conventional Type-C electrical connectors, when the connector is mated with or unmated from a corresponding mating device, electrical arcing may occur between terminals, which can lead to short circuits and potentially damage internal components of a system.

### SUMMARY OF THE DISCLOSURE

In response to the above-referenced technical inadequacy, the present disclosure provides an electrical connection device in which no arc discharge phenomenon occurs and which can effectively protect internal components of a system.

In order to solve the above-mentioned problems, one of the technical aspects adopted by the present disclosure is to provide an electrical connection device, which includes a base; a terminal set disposed on the base, in which the terminal set includes a plurality of terminals; a circuit board, in which one end of each of the plurality of terminals is electrically connected to the circuit board; a switch unit electrically connected to the circuit board; a housing covering and enclosing the base and the circuit board; and a grip member, in which the grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions. When the grip member moves along the insertion direction and the withdrawal direction, the grip member is configured to control the switch unit to be turned on and off. When the electrical connection device is plugged into or unplugged from a mating electronic device, conduction occurs only after complete plugging of the electrical connection device, and power is cut off before complete unplugging of the electrical connection device.

In one of the possible or preferred embodiments, one of the terminals includes a first segment, a second segment and a third segment, the first segment and the second segment are connected by a fold line, the second segment and the third segment are disposed at intervals, and the second segment and the third segment are located on a straight line; wherein the first segment and the second segment are bent by the fold line, so that the first segment is partially stacked on the second segment, and a portion of the first segment not stacked on the second segment is bent to form a resilient arm; and wherein the resilient arm is located above the third segment, thereby forming the switch unit.

In order to solve the above-mentioned problems, another one of the technical aspects adopted by the present disclosure is to provide an electrical connection device, which includes a base; a terminal set disposed on the base; a switch unit electrically connected to the terminal set; a housing covering and enclosing the base; and a grip member, in which the grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions. When the grip member moves along the insertion direction and the withdrawal direction, the grip member is configured to control the switch unit to be turned on and off. When the electrical connection device is plugged into or unplugged from a mating electronic device, conduction occurs only after complete plugging of the electrical connection device, and power is cut off before complete unplugging of the electrical connection device.

The beneficial effects of the present disclosure include that the electrical connection device provided by the present disclosure includes a base, a terminal set, a circuit board, a switch unit, a housing, and a grip member. The terminal set is disposed on the base, and the terminal set includes a plurality of terminals. One end of each of the plurality of terminals is electrically connected to the circuit board. The switch unit is electrically connected to the circuit board. The housing covers and encloses the base and the circuit board. The grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions. When the grip member moves along the insertion direction and the withdrawal direction, the grip member is configured to control the switch unit to be turned on and off. When the electrical connection device is plugged into or unplugged from a mating electronic device, conduction occurs only after complete plugging of the electrical connection device, and power is cut off before complete unplugging of the electrical connection device. Therefore, when the electrical connection device is plugged into or unplugged from the mating electronic device, no arc discharge phenomenon occurs, and internal components of the system can be effectively protected.

Furthermore, one of the terminals includes a first segment, a second segment and a third segment, the first segment and the second segment are connected by a fold line, the second segment and the third segment are disposed at intervals, and the second segment and the third segment are located on a straight line; wherein the first segment and the second segment are bent by the fold line, so that the first segment is partially stacked on the second segment, and a portion of the first segment not stacked on the second segment is bent to form a resilient arm; and wherein the resilient arm is located above the third segment, thereby forming the switch unit. Therefore, the terminal can be used to form the switch unit, so that the overall structure can be further simplified, thereby reducing costs.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an electrical connection device according to a first embodiment of the present disclosure;

FIG. 2 is a schematic view of the electrical connection device in a closed state according to the first embodiment of the present disclosure;

FIG. 3 is a schematic view of the electrical connection device in an opened state according to the first embodiment of the present disclosure;

FIG. 4 is a schematic view of the electrical connection device in a closed state according to a second embodiment of the present disclosure;

FIG. 5 is a schematic view of the electrical connection device in an opened state according to the second embodiment of the present disclosure;

FIG. 6 is a schematic view of a switch unit of the electrical connection device according to a third embodiment of the present disclosure;

FIG. 7 is a schematic view of the electrical connection device in a closed state according to a fourth embodiment of the present disclosure;

FIG. 8 is a schematic view of the switch unit of the electrical connection device according to a fifth embodiment of the present disclosure;

FIG. 9 is a schematic view of the electrical connection device in a closed state according to a sixth embodiment of the present disclosure;

FIG. 10 is a schematic view of the electrical connection device in an opened state according to the sixth embodiment of the present disclosure;

FIG. 11 is a schematic view of the switch unit of the electrical connection device according to a seventh embodiment of the present disclosure;

FIG. 12 is a schematic view of the electrical connection device in a closed state according to an eighth embodiment of the present disclosure;

FIG. 13 is a schematic perspective view of the electrical connection device according to a ninth embodiment of the present disclosure;

FIG. 14 is a schematic perspective view of the electrical connection device in a closed state according to a tenth embodiment of the present disclosure;

FIG. 15 is a schematic perspective view of the electrical connection device in an opened state according to the tenth embodiment of the present disclosure;

FIG. 16 is a schematic view of an unfolded terminal according to the tenth embodiment of the present disclosure;

FIG. 17 is a schematic view of a terminal folded along a fold line according to the tenth embodiment of the present disclosure; and

FIG. 18 is a schematic perspective view of the electrical connection device according to an eleventh embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. It should be noted that the examples provided in the following description are merely illustrative embodiments and are not intended to limit the scope of the present disclosure.

### First Embodiment

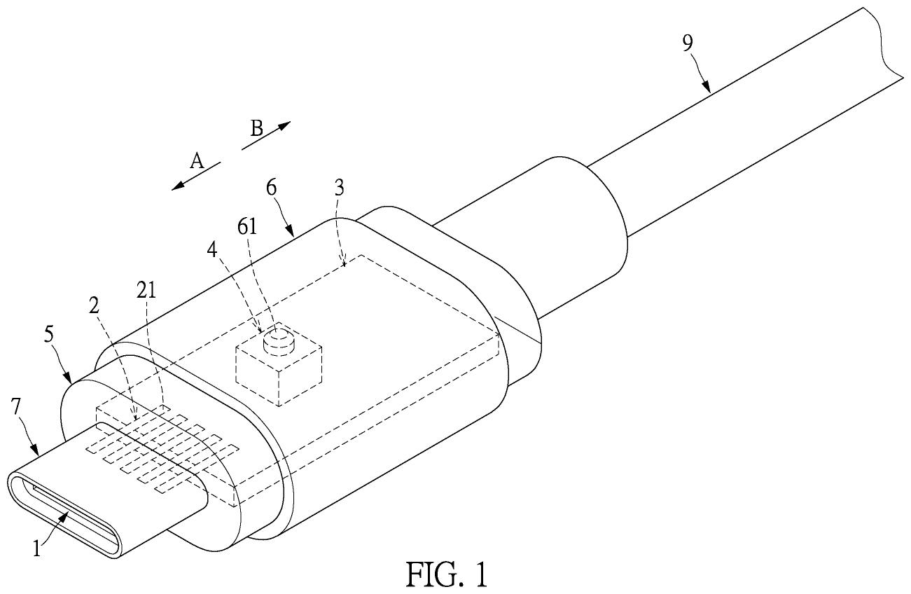

Referring to FIGS. 1 to 3, the present disclosure provides an electrical connection device, which can comply with (conform to) the Type-C specification (or the electrical connection device is configured to mate with a USB Type-C receptacle) and can be applied to a plug electrical connector or a receptacle electrical connector. This embodiment discloses a plug electrical connector. The electrical connection device comprises a base 1, a terminal set 2, a circuit board 3, a switch unit 4 (or switching unit), a housing 5, and a grip member 6.

The base 1 is made of an insulating material such as plastic. The terminal set 2 is disposed on the base 1, the terminal set 2 may be disposed inside or outside the base 1. In this embodiment, the base 1 is a hollow body, so that the terminal set 2 can be disposed inside the base 1.

The terminal set 2 includes a plurality of terminals 21. The plurality of terminals 21 are made of a metal material with good conductivity. The plurality of terminals 21 may be arranged in upper and lower rows. The plurality of terminals 21 may be disposed at inner top-side and bottom-side positions of the base 1. One end (distal end) of each of the plurality of terminals 21 may extend out of the base 1, and one end of each of the plurality of terminals 21 is electrically connected to the circuit board 3. A metal shell 7 may also be disposed outside the base 1. The metal shell 7 may be used to protect the base 1 and the terminal set 2 and may provide an electromagnetic shielding effect. The circuit board 3 may also be electrically connected to a transmission line 9.

The circuit board 3 is disposed behind the base 1, and the circuit board 3 is electrically connected to the plurality of terminals 21. The switch unit 4 may be disposed on the circuit board 3. The switch unit 4 is electrically connected to the circuit board 3. The structure of the switch unit 4 is not limited, and the switch unit 4 may be various switch elements such as a micro switch, a spring plate, a pogo pin, or a sensor.

The housing 5 is made of an insulating material such as plastic, and the housing 5 is configured as a cover disposed outside the base 1 and the circuit board 3. One end (front side) of the base 1 and the metal shell 7 may extend out of the housing 5, so that the base 1 and the terminal set 2 can be plugged into a mating electronic device 100 (or peripheral electronic device, or external electronic device, or docking electronic device) to achieve electrical connection.

The grip member 6 is made of an insulating material such as plastic the grip member 6 is a hollow shell, and the grip member 6 may be an integral structure. The grip member 6 has an actuating portion 61, which may be located at a lower horizontal height. The grip member 6 is sleeved on (or disposed around) an outer side of the housing 5, and the grip member 6 can move on the housing 5. That is to say, the grip member 6 can move on the housing 5 along an insertion direction A (or plugging direction) and a withdrawal direction B (or unplugging direction). The insertion direction A is a direction in which the electrical connection device engages with the mating electronic device 100, the withdrawal direction B is a direction in which the electrical connection device separates from the mating electronic device 100, and the insertion direction A and the withdrawal direction B are two opposite directions. The grip member 6 is sleeved on an outer side of the housing 5. A predetermined tightness is provided between the housing 5 and the grip member 6, so that the grip member 6 can be properly positioned on the housing 5, allowing the grip member 6 to drive the entire electrical connection device to perform plugging and unplugging operations. The housing 5 and the grip member 6 are not limited to being made of plastic and may also be made of metal or other materials.

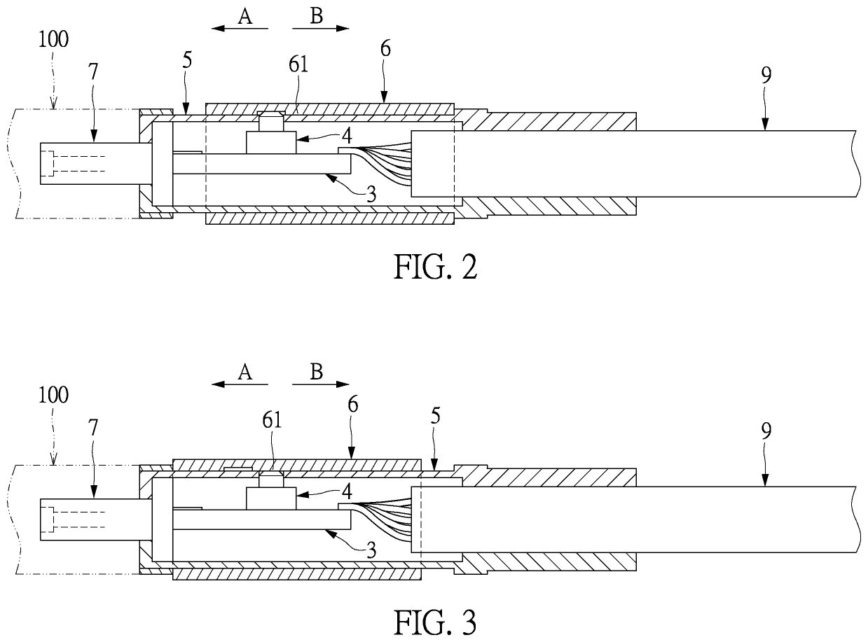

When the grip member 6 moves along the insertion direction A and the withdrawal direction B, the grip member 6 can be used to control the switch unit 4 so as to turn the switch unit 4 on or off. Specifically, a user may hold the grip member 6 to drive the electrical connection device to perform plugging and unplugging operations. When the user holds the electrical connection device, the grip member 6 may be used to drive the electrical connection device to be plugged into the mating electronic device 100. When the electrical connection device is plugged into the mating electronic device 100, there is a predetermined tightness between the housing 5 and the grip member 6, the grip member 6 does not move relative to the housing 5, and the grip member 6 can move together with the housing 5 (or the grip member 6 can be configured to move in synchronization with the housing 5). When the electrical connection device is plugged into the mating electronic device 100 to a positioned state (that is to say, when the electrical connection device is completely plugged into the mating electronic device 100 as shown in FIG. 2), and when the housing 5 abuts against the front side of the mating electronic device 100, the housing 5 is stopped and positioned, the grip member 6 starts to move relative to the housing 5, and then the grip member 6 continues to move along the insertion direction A (as shown in FIG. 3), so that the actuating portion 61 of the grip member 6 actuates (or controls) the switch unit 4 to turn on the switch unit 4 to facilitate power transmission to the electrical connection device. Since the electrical connection device starts to conduct and transmit power only after the electrical connection device has been completely plugged into the mating electronic device 100, the occurrence of an arc discharge phenomenon can be effectively avoided.

When the user holds the electrical connection device, the grip member 6 may also be used to drive the electrical connection device to separate from the mating electronic device 100. When the electrical connection device is separated from the mating electronic device 100, there is also a certain tightness between the electrical connection device and the mating electronic device 100, the mating electronic device 100 can be used to temporarily position the base 1 and the housing 5, so that the grip member 6 can move relative to the housing 5, and the grip member 6 can move along the withdrawal direction B (as shown in FIG. 2), causing the actuating portion 61 of the grip member 6 to leave the switch unit 4, thereby turning off the switch unit 4 to prevent power from being transmitted to electrical connection device. Therefore, the grip member 6 can continue to move along the withdrawal direction B so as to drive the electrical connection device to separate from the mating electronic device 100. Since the electrical connection device is already powered off before the electrical connection device is separated from the mating electronic device 100, the occurrence of an arc discharge phenomenon can be effectively avoided.

### Second Embodiment

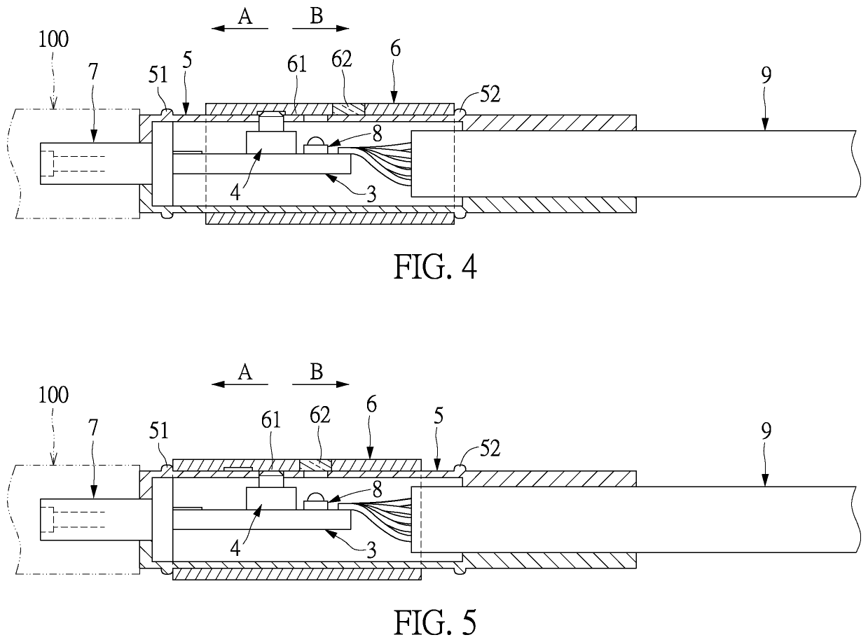

Referring to FIGS. 4 and 5, in this embodiment, the circuit board 3 may also be electrically connected to a light-emitting element 8 (or light-emitting assembly), and the light-emitting element 8 may be a light-emitting diode, a bulb, or the like. The housing 5 and the grip member 6 may also be light-transmissive, or a light-transmissive portion 62 corresponding to the light-emitting element 8 may be provided, so that light emitted by the light-emitting element 8 can radiate outward through the light-transmissive portion 62. When the switch unit 4 is actuated to be turned on (as shown in FIG. 5), the light emitted by the light-emitting element 8 can radiate outward to produce a light display effect, allowing a user to know that the electrical connection device is in a conductive state. In addition, a front positioning portion 51 and a rear positioning portion 52 may also be provided on the housing 5. When the grip member 6 moves along the insertion direction A to a predetermined position, the grip member 6 can abut against the front positioning portion 51 and be positioned. When the grip member 6 moves along the withdrawal direction B to another predetermined position, the grip member 6 can abut against the rear positioning portion 52 and be positioned.

### Third Embodiment

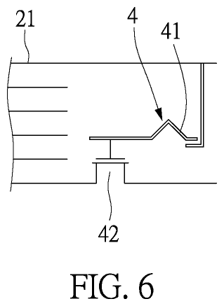

Referring to FIG. 6, in this embodiment, the switch unit 4 may include a tactile switch 41 and an electronic switch 42. The electronic switch 42 may be a type of switch circuit belonging to a metal-oxide-semiconductor (MOS). The tactile switch 41 is connected to the electronic switch 42, and the tactile switch 41 and the electronic switch 42 are electrically connected between two terminals 21 respectively serving as a power supply terminal and a ground terminal. When the grip member 6 moves along the insertion direction A and the withdrawal direction B, the grip member 6 can be used to press or release the tactile switch 41 of the switch unit 4 so as to drive the electronic switch 42 to perform a switching operation, thereby turning the switch unit 4 on or off through the grip member 6.

### Fourth Embodiment

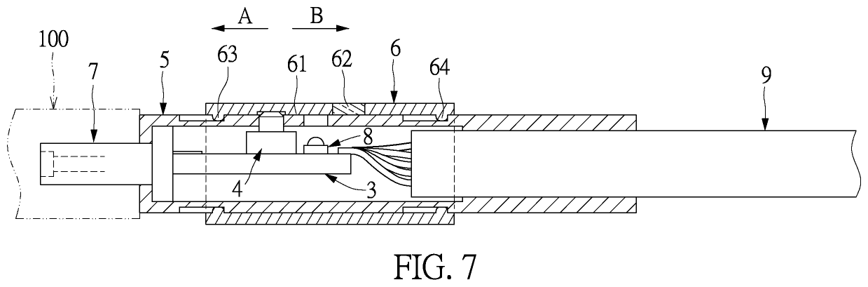

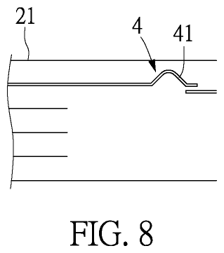

Referring to FIG. 7, in this embodiment, a front protrusion 63 and a rear protrusion 64 may also be provided on the grip member 6. When the grip member 6 moves along the insertion direction A to a predetermined position, the front protrusion 63 of the grip member 6 can abut against the housing 5 and be positioned. When the grip member 6 moves along the withdrawal direction B to another predetermined position, the rear protrusion 64 of the grip member 6 can abut against the housing 5 and be positioned.

### Fifth Embodiment

Referring to FIG. 8, in this embodiment, the switch unit 4 may also be disposed on the terminal 21 of the terminal set 2. That is to say, the tactile switch 41 may be formed by extension from the terminal 21, so that the switch unit 4 is electrically connected to the circuit board 3, thereby further simplifying the overall structure and reducing the cost.

### Sixth Embodiment

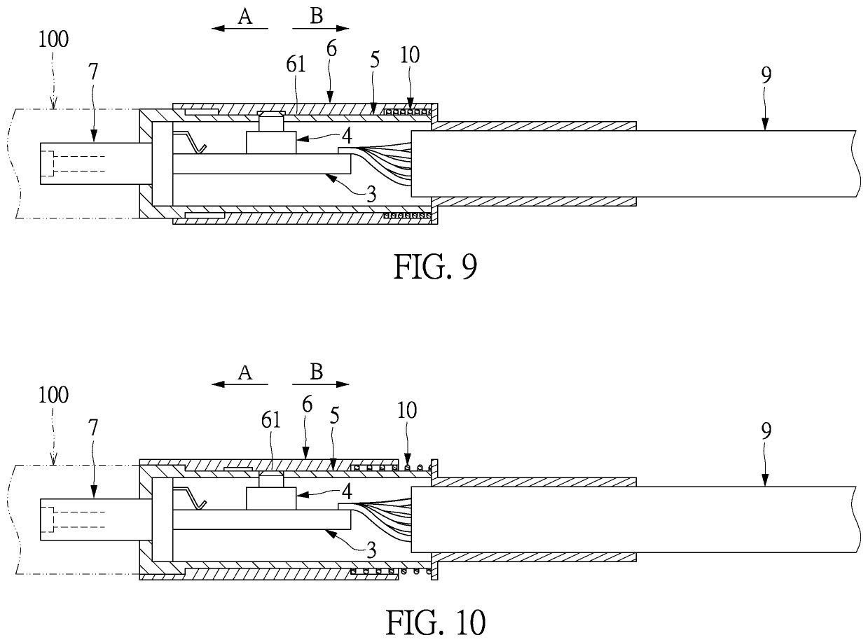

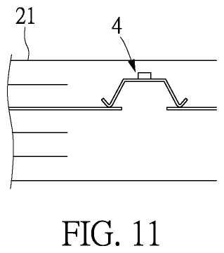

Referring to FIGS. 9 and 10, in this embodiment, an elastic member 10 may also be disposed between the grip member 6 and the housing 5. The elastic member 10 can push the grip member 6 to move along the insertion direction A, so that the actuating portion 61 of the grip member 6 can actuate the switch unit 4 to turn on the switch unit 4, allowing the electrical connection device to conduct and transmit power when the user releases his or her hand.

### Seventh Embodiment

Referring to FIG. 11, in this embodiment, the switch unit 4 may also be a slide switch. The grip member 6 can be used to actuate and push the switch unit 4 so as to control the switch unit 4 to be turned on and off.

### Eighth Embodiment

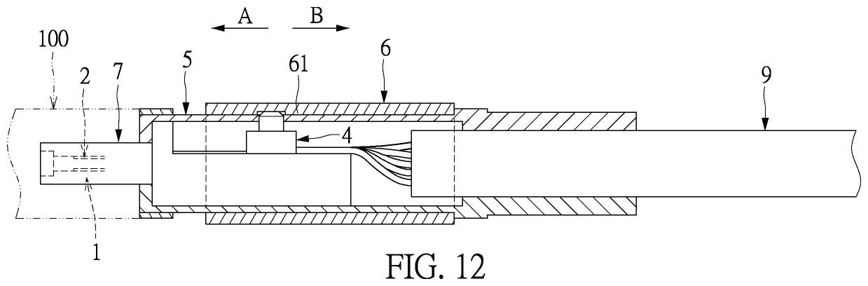

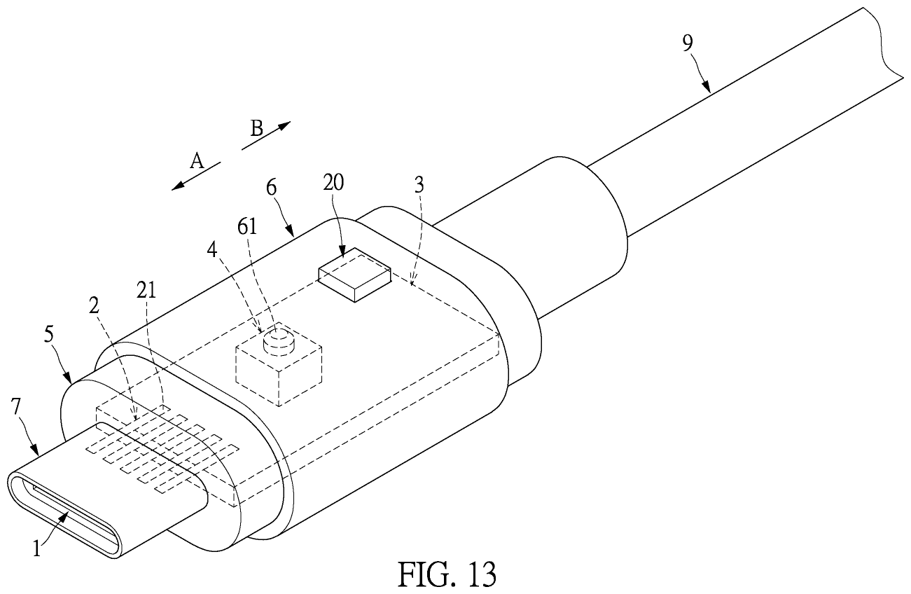

Referring to FIG. 12, in this embodiment, the circuit board 3 in the above embodiments is mainly omitted. The electrical connection device of this embodiment includes a base 1, a terminal set 2, a switch unit 4, a housing 5, and a grip member 6. The terminal set 2 is disposed on the base 1, the switch unit 4 is electrically connected to terminal set 2, and the housing 5 covers the base 1. The grip member 6 is a hollow shell, the grip member 6 has an actuating portion 61 that can be used to actuate the grip member 6, and the grip member 6 is sleeved on an outer side of the housing 5. The grip member 6 can move on the housing 5 along the insertion direction A and the withdrawal direction B, and the insertion direction A and the withdrawal direction B are two opposite directions. When the grip member 6 moves along the insertion direction A and the withdrawal direction B, the grip member 6 can be used to control the switch unit 4 to be turned on and off, so that when the electrical connection device is plugged into or unplugged from the mating electronic device 100, the electrical connection device and the mating connection device 100 are electrically connected with each other after they are connected with each other (the plugging action is completed), and the electrical connection device and the mating connection device 100 are de-energized before they are separated (the unplugging action is completed).

### Ninth Embodiment

Referring to FIG. 13, in this embodiment, a touch control switch 20 (or touch-sensitive switch) may also be disposed on the grip member 6, and the touch control switch 20 is electrically connected to the circuit board 3. A user can control the electrical connection device to be turned on and off by touching and leaving the touch control switch 20. The electrical connection device is turned on immediately when the user's hand touches the touch control switch 20. In another embodiment, the grip member 6 may also be made into a fixed member, so that the grip member 6 can be fixed on an outer side of the housing 5. The power on/off is controlled entirely by the touch control switch 20, such that when the electrical connection device is plugged into or unplugged from the mating connection device, the touch control switch 20 ensures that conduction occurs only after full insertion, and power is disconnected before extraction.

### Tenth Embodiment

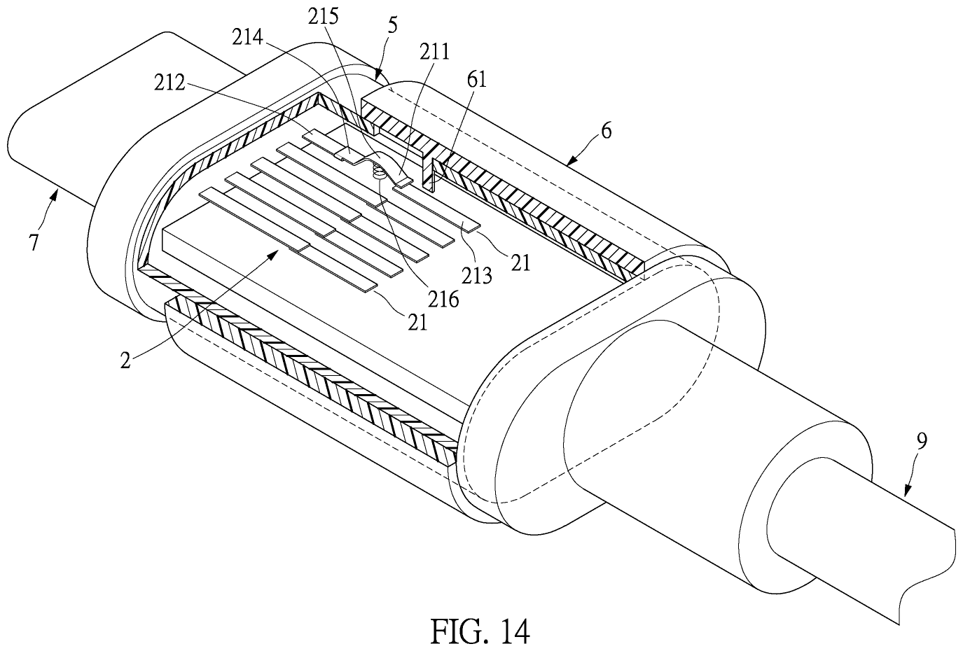

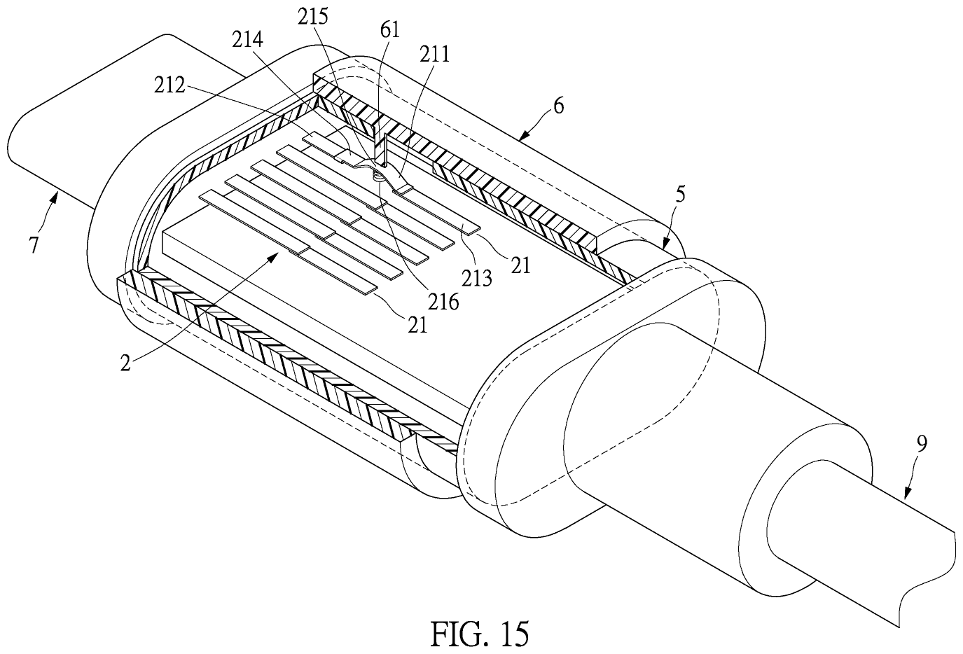

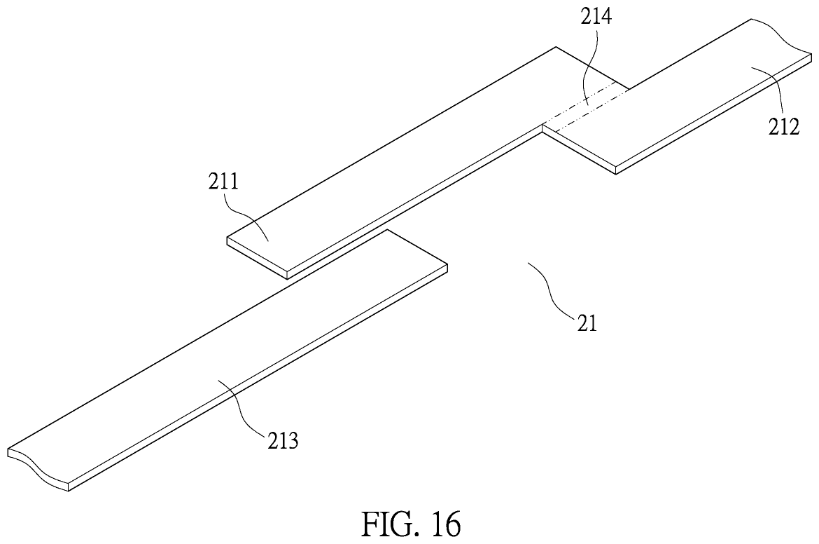

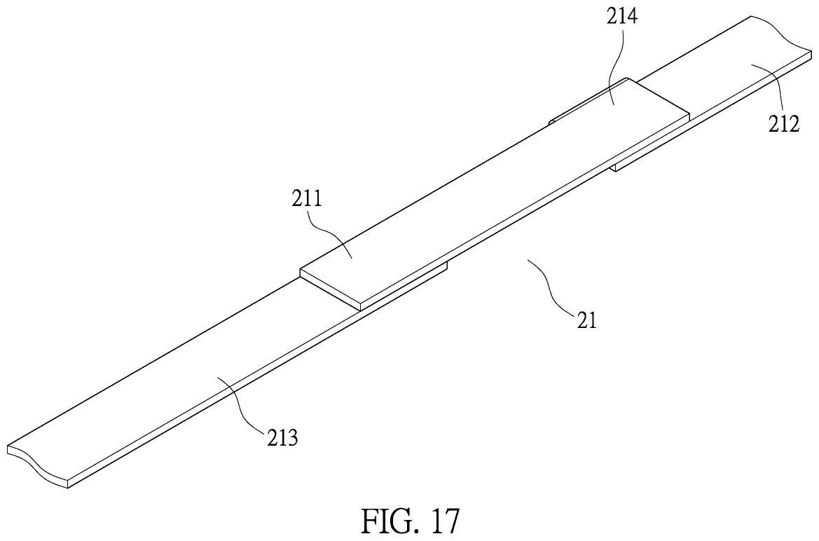

Referring to FIGS. 14 to 17, in this embodiment, the terminal set 2 includes a plurality of terminals 21. The plurality of terminals 21 are made of a metal material with good conductivity. One of the terminals 21 includes a first segment 211, a second segment 212, and a third segment 213. The first segment 211 and the second segment 212 are connected by a fold line 214. The length of the second segment 212 is smaller than the length of the first segment 211. The second segment 212 and the third segment 213 are disposed at intervals. The second segment 212 and the third segment 213 are located on a straight line. The first segment 211 and the second segment 212 can be bent by the fold line 214, so that the first segment 211 is partially stacked on the second segment 212, a portion of the first segment 211 not stacked on the second segment 212 is bent to form a resilient arm 215 (as shown in FIGS. 14 and 15), and the resilient arm 215 is located above the third segment 213, thereby forming the switch unit 4. The actuating portion 61 of the grip member 6 can actuate the resilient arm 215 of the switch unit 4, so that the resilient arm 215 contacts and conducts the third segment 213. The actuating portion 61 of the grip member 6 can also leave the resilient arm 215 of the switch unit 4, so that the resilient arm 215 is disengaged and disconnected from the third segment 213. A reset elastic member 216 may also be disposed below the resilient arm 215, and the reset elastic member 216 can push the resilient arm 215 upward to provide resetting elasticity for the resilient arm 215.

The actuating portion 61 of the grip member 6 can be used to actuate the grip member 6. When the grip member 6 moves along the insertion direction and the withdrawal direction, the grip member 6 can be used to control the switch unit 4 to be turned on and off, so that when the electrical connection device is plugged into or unplugged from the mating electronic device, the conduction occurs only after complete insertion, and the power is cut off before unplugging.

### Eleventh Embodiment

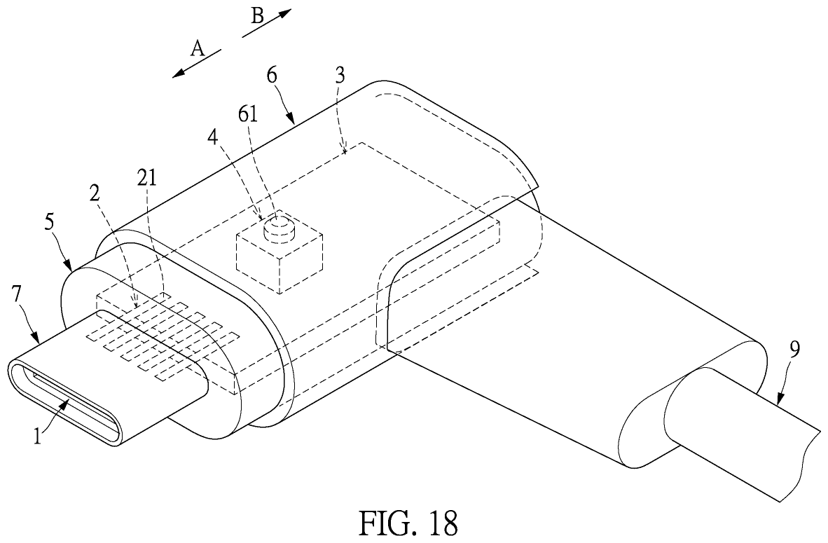

Referring to FIG. 18, in this embodiment, an outlet direction (or outgoing direction) of the transmission line 9 is perpendicular to the insertion direction A and the withdrawal direction B.

### Beneficial Effects of the Embodiments

The beneficial effects of the present disclosure include that the electrical connection device provided by the present disclosure includes a base, a terminal set, a circuit board, a switch unit, a housing, and a grip member. The terminal set is disposed on the base, and the terminal set includes a plurality of terminals. One end of each of the plurality of terminals is electrically connected to the circuit board. The switch unit is electrically connected to the circuit board. The housing covers and encloses the base and the circuit board. The grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions. When the grip member moves along the insertion direction and the withdrawal direction, the grip member is configured to control the switch unit to be turned on and off. When the electrical connection device is plugged into or unplugged from a mating electronic device, conduction occurs only after complete plugging of the electrical connection device, and power is cut off before complete unplugging of the electrical connection device. Therefore, when the electrical connection device is plugged into or unplugged from the mating electronic device, no arc discharge phenomenon occurs (to prevent arc discharge during insertion and withdrawal), and internal components of the system can be effectively protected.

Furthermore, one of the terminals includes a first segment, a second segment and a third segment, the first segment and the second segment are connected by a fold line, the second segment and the third segment are disposed at intervals, and the second segment and the third segment are located on a straight line; wherein the first segment and the second segment are bent by the fold line, so that the first segment is partially stacked on the second segment, and a portion of the first segment not stacked on the second segment is bent to form a resilient arm; and wherein the resilient arm is located above the third segment, thereby forming the switch unit. Therefore, the terminal can be used to form the switch unit, so that the overall structure can be further simplified, thereby reducing costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connection device, comprising:
a base;
a terminal set disposed on the base, wherein the terminal set includes a plurality of terminals;
a circuit board, wherein one end of each of the plurality of terminals is electrically connected to the circuit board;
a switch unit electrically connected to the circuit board;
a housing covering and enclosing the base and the circuit board; and
a grip member, wherein the grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions;
wherein, when the grip member moves along the insertion direction and the withdrawal direction, the grip member is configured to control the switch unit to be turned on and off; and
wherein, when the electrical connection device is plugged into or unplugged from a mating electronic device, conduction occurs only after complete plugging of the electrical connection device, and power is cut off before complete unplugging of the electrical connection device.

2. The electrical connection device according to claim 1, wherein the electrical connection device complies with a Type-C specification.

3. The electrical connection device according to claim 1, wherein the plurality of terminals are arranged in upper and lower rows, the plurality of terminals are disposed at inner top-side and bottom-side positions of the base, one end of each of the plurality of terminals extends out of the base, a metal shell is disposed outside the base, and one end of the base and one end of the metal shell extend out of the housing.

4. The electrical connection device according to claim 1, wherein a reset elastic member is disposed below a resilient arm, and the reset elastic member is configured to upwardly push the resilient arm.

5. The electrical connection device according to claim 1,
wherein, when the electrical connection device is plugged into the mating electronic device, the grip member does not move relative to the housing;
wherein, when the electrical connection device is plugged into the mating electronic device to a positioned state, the housing abuts against a front side of the mating electronic device, and the housing is stopped and positioned; and
wherein, when the grip member starts to move relative to the housing and moves along the insertion direction, the actuating portion of the grip member is configured to actuate the switch unit to turn on the switch unit, thereby allowing the electrical connection device to conduct and transmit power.

6. The electrical connection device according to claim 1, wherein, when the electrical connection device is separated from the mating electronic device, the grip member moves relative to the housing, the grip member moves along the withdrawal direction, so that the actuating portion of the grip member leaves the switch unit to turn off the switch unit, whereby the electrical connection device does not conduct to transmit power, and the grip member moves along the withdrawal direction so as to drive the electrical connection device to separate from the mating electronic device.

7. The electrical connection device according to claim 1, wherein the circuit board is electrically connected to a light-emitting element; and wherein, when the switch unit is turned on, light emitted by the light-emitting element radiates outward to produce a light display effect.

8. The electrical connection device according to claim 1, wherein the switch unit includes a tactile switch and an electronic switch, the tactile switch is connected to the electronic switch, and the tactile switch and the electronic switch are electrically connected to the terminals; and wherein, when the grip member moves along the insertion direction and the withdrawal direction, the grip member is configured to press or release the tactile switch so as to drive the electronic switch to perform a switching operation, thereby turning the switch unit on or off.

9. The electrical connection device according to claim 1, wherein a front positioning portion and a rear positioning portion are disposed on the housing; wherein, when the grip member moves along the insertion direction, the grip member abuts against the front positioning portion and is positioned; and wherein, when the grip member moves along the withdrawal direction, the grip member abuts against the rear positioning portion and is positioned.

10. The electrical connection device according to claim 1, wherein a front protrusion and a rear protrusion are disposed on the grip member; wherein, when the grip member moves along the insertion direction, the front protrusion of the grip member abuts against the housing and is positioned; and wherein, when the grip member moves along the withdrawal direction, the rear protrusion of the grip member abuts against the housing and is positioned.

11. The electrical connection device according to claim 1, wherein the switch unit is disposed on the terminal of the terminal set.

12. The electrical connection device according to claim 1, wherein an elastic member is disposed between the grip member and the housing, and the elastic member is configured to push the grip member to move along the insertion direction.

13. The electrical connection device according to claim 1, wherein a touch control switch is disposed on the grip member, the touch control switch is electrically connected to the circuit board, and the touch control switch is configured to control the conduction and deactivation of the electrical connection device by touching.

14. The electrical connection device according to claim 1, wherein one of the terminals includes a first segment, a second segment and a third segment, the first segment and the second segment are connected by a fold line, the second segment and the third segment are disposed at intervals, and the second segment and the third segment are located on a straight line; wherein the first segment and the second segment are bent by the fold line, so that the first segment is partially stacked on the second segment, and a portion of the first segment not stacked on the second segment is bent to form a resilient arm; and wherein the resilient arm is located above the third segment, thereby forming the switch unit.

15. An electrical connection device, comprising:
a base;
a terminal set disposed on the base;
a switch unit electrically connected to the terminal set;
a housing covering and enclosing the base; and
a grip member, wherein the grip member is a hollow shell, the grip member has an actuating portion, the actuating portion is configured to actuate the switch unit, the grip member is disposed around the housing, the grip member is configured to be moved on the housing along an insertion direction and a withdrawal direction, and the insertion direction and the withdrawal direction are two opposite directions;
wherein, when the grip member moves along the insertion direction and the withdrawal direction, the grip member is configured to control the switch unit to be turned on and off; and
wherein, when the electrical connection device is plugged into or unplugged from a mating electronic device, conduction occurs only after complete plugging of the electrical connection device, and power is cut off before complete unplugging of the electrical connection device.

16. The electrical connection device according to claim 15, wherein the terminal set includes a plurality of terminals, one of the terminals includes a first segment, a second segment and a third segment, the first segment and the second segment are connected by a fold line, the second segment and the third segment are disposed at intervals, and the second segment and the third segment are located on a straight line; wherein the first segment and the second segment are bent by the fold line, so that the first segment is partially stacked on the second segment, and a portion of the first segment not stacked on the second segment is bent to form a resilient arm; and wherein the resilient arm is located above the third segment, thereby forming the switch unit.
